(19) United States
(12) Patent Application Publication
(10) Pub. No.: US 2010/0113011 A1
(43) Pub. Date: May 6, 2010

(54) WIRELESS ELECTRONIC DEVICE TESTING SYSTEM

(76) Inventors: Justin Gregg, San Francisco, CA (US); Louie J. Sanguinetti, Los Gatos, CA (US); Tomoki Takeya, Santa Clara, CA (US)

Correspondence Address: Treyz Law Group, 870 Market Street, Suite 984, SAN FRANCISCO, CA, 94102, US

(21) Appl. No.: 12/266,536

(22) Filed: Nov. 6, 2008

(51) Int. Cl. H04W 24/00

(52) U.S. Cl. 455/425

(57) ABSTRACT

Cellular telephones and other wireless electronic devices may be tested using test equipment. The test equipment may include a call box and a test host. During testing, a wireless electronic device may be placed in a test chamber. The test chamber may include an antenna that is connected to the test equipment. The test equipment may use the antenna to communicate wirelessly with the wireless electronic device during testing. The wireless electronic device may communicate with the test equipment using messages that are compliant with cellular telephone communications protocols such as short message service (SMS) messages. These wireless messages may be used to convey test information to the test equipment from the wireless electronic device. These wireless messages may also be used to send control commands to the wireless electronic device during testing and to store test results in the wireless electronic device.

### BACKGROUND

This invention relates to electronic devices, and more particularly, to testing wireless electronic devices.

Electronic devices such as cellular telephones have wireless capabilities. These wireless capabilities may be used to support voice and data traffic. During manufacturing, wireless electronic devices are generally tested to determine whether their wireless functions are operating properly. For example, a test probe may be attached to a wireless device to determine whether its radio-frequency transceiver circuitry is able to properly generate radio-frequency output signals.

Tests may also be performed that involve transmitting and receiving actual radio-frequency telephone call signals. In a typical scenario, test equipment referred to as a “call box” is used to send and receive protocol-compliant radio-frequency test data to a wireless device under test. Call box test equipment can handle bidirectional signaling-type test transmissions similar to full-fledged cellular telephone calls. If the call box determines that the device is not performing properly, the device may be repaired or discarded.

The results from call box wireless tests are stored in the tested device. For example, test results may be stored that indicate the amount of power that was wirelessly transmitted to the call box from the tested device during testing. These test results may also identify the call box that was used in performing the test. The stored test results may be helpful in the event that the device ever needs to be serviced. Stored test results may, for example, be useful in improving testing and manufacturing procedures.

Conventional test arrangements such as these require that tested devices be tethered to the test equipment during testing. Prior to a given test, a data cable is typically connected to a device to perform setup operations. Information such as the device's serial number may be gathered. After testing is complete, test results may be stored in the device using the data cable.

If the test cable is removed in the middle of a test, there is a possibility that errors can arise. For example, if care is not taken, the cable might be connected to the wrong device so that test results that correspond to one device may be written into the memory of another device. Disconnecting and reconnecting the test cable is also cumbersome and can slow test throughput.

To avoid the potential for errors that arises from detaching the data cable during testing, testing is generally completed without ever removing the data cable from the device under test. Although this helps to prevent errors from improperly connected cables, the presence of the data cable during testing can adversely affect test accuracy.

Each data cable has a metal connector that plugs into the device under test. The connector is conductive and can therefore influence test results. For example, the connector may affect the radio-frequency ground of antennas in the device and may therefore have an impact on antenna performance. The connector may also provide a ground path for interference signals in the device. Interference signals may be generated by integrated circuits within the device during normal operation. When the connector is present, the grounding effect of the connector may abnormally diminish the influence of the interference circuits making device performance appear better than it should.

It would therefore be desirable to provide improved ways in which to test wireless electronic devices such as cellular telephones.

### SUMMARY

Wireless electronic devices such as cellular telephones may communicate with test equipment using messages that are compliant with cellular telephone communications protocols such as the short message service (SMS) protocol. The test equipment may perform protocol-compliant radio-frequency signaling tests on a wireless electronic device while the wireless electronic device is in a test chamber.

The test equipment may include a call box and a test host. The test host may maintain a manufacturing database in which test results may be stored. The test chamber that contains the wireless electronic device under test may include an antenna. The call box may be connected to the antenna using a cable. During testing, the call box may use the antenna in the test chamber to perform wireless measurements on the wireless electronic device. The wireless measurements may include bit error rate tests, tests of receiver sensitivity and transmit power, frame error rate tests, adjacent channel power measurements, and other radio-frequency signal tests.

The call box may also use the antenna to send messages to the electronic device and to receive messages from the electronic device. The wireless electronic device may send a message to the test equipment that provides the test equipment with identifying information and information on the type of test that is to be performed. The test equipment may send one or more messages to the electronic device to control the electronic device during testing. For example, the test equipment may send a wireless control message to the wireless electronic device that places the wireless electronic device into a sleep mode in preparation for certain tests. Test results that are gathered by the test equipment may be transmitted to the electronic device in a wireless message. The electronic device may store the received test results in memory.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of a wireless electronic device such as a cellular telephone that may be tested in accordance with an embodiment of the present invention.

FIG. 2 is a perspective view of an illustrative radio-frequency test chamber that may be used to test a wireless electronic device in accordance with an embodiment of the present invention.

FIG. 3 is a diagram of test equipment that may be used in performing radio-frequency tests using a radio-frequency test chamber of the type shown in FIG. 2 on a wireless electronic device of the type shown in FIG. 1 in accordance with an embodiment of the present invention.

FIG. 4 is a diagram of a test system of the type that may be used in testing wireless electronic devices in accordance with an embodiment of the present invention.

FIG. 5 is a flow chart of a conventional process for testing cellular telephones.

FIG. 6 is a flow chart of illustrative steps involved in testing a wireless electronic device in accordance with an embodiment of the present invention.

### DETAILED DESCRIPTION

The present invention relates to electronic devices such as cellular telephones and other devices that use wireless communications. In devices such as these, it is generally desirable to perform tests during manufacturing. These tests may include tests of the radio-frequency circuitry on the device. For example, a probe may be attached to a radio-frequency (RF) connector on an electronic device. A power meter or other test equipment may monitor the power level at the RF connector to ensure that an adequate level of transmitted RF power is being produced.

In addition to performing probe-based tests, it is often desirable to perform wireless signaling tests. Tests such as these use protocol-compliant test equipment to communicate wirelessly with a device under test. For example, when testing a 3G cellular telephone, test equipment can be used that is compliant with 3 G communications protocols. Because this type of protocol-compliant test equipment is used in sending and receiving wireless data in a format that closely resembles that used in actual cellular telephone calls, the protocol-compliant test equipment such as this is sometimes referred to as “call box” equipment or a “call box.” Call boxes for testing cellular telephones such as the CMU200 universal radio-communications tester are available commercially from Rohde & Schwarz.

Wireless tests performed using call box equipment may reveal whether the antennas and associated wireless circuitry in a wireless device are performing properly. If a wireless device fails a call box test, the device may be repaired or discarded.

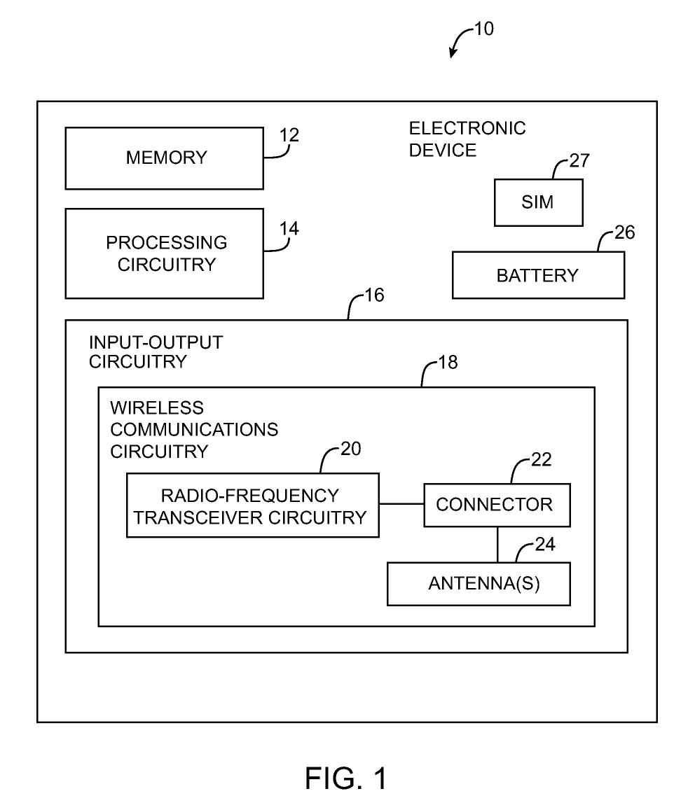

A diagram of a wireless device such as a cellular telephone that may be tested using call box equipment is shown in FIG. 1. As shown in FIG. 1, device 10 may include memory 12, processing circuitry 14, and input-output circuitry 16.

Memory 12 may include volatile and non-volatile storage such as random-access memory and read-only memory (e.g., flash). Memory 12 may also include hard drive storage and other types of storage hardware. Memory 12 may be implemented using separate integrated circuits and/or using memory blocks that are provided as part of processors or other integrated circuits.

Processing circuitry 14 may be used to control the operation of device 10. Processing circuitry 14 may be based on one or more circuits such as a microprocessor, a microcontroller, a digital signal processor, an application-specific integrated circuit, and other suitable integrated circuits. With one suitable arrangement, processing circuitry 14 and storage 12 are used to run software on device 10 such as telephone call applications, email applications, media playback applications, games, business productivity applications, operating system functions, etc. Processing circuitry 14 and storage 12 may be used to help device 10 in implementing wireless communications protocols such as wireless local area network protocols (e.g., IEEE 802.11 protocols—sometimes referred to as Wi-Fi®), protocols for other short-range wireless communications links such as the Bluetooth® protocol, protocols for handling 3 G communications services (e.g., using wide band code division multiple access techniques), 2G cellular telephone communications protocols, WiMAX® communications protocols, communications protocols for other bands, etc.

Input-output devices 16 may be used to allow data to be supplied to device 10 and to allow data to be provided from device 10 to external devices. Input-output devices 16 may include user input-output devices such as buttons, display screens, touch screens, joysticks, click wheels, scrolling wheels, touch pads, key pads, keyboards, microphones, speakers, cameras, etc. A user can control the operation of device 10 by supplying commands through the user input devices.

As shown in FIG. 1, input-output devices 16 may include wireless communications circuitry Wireless communications circuitry 18 may include communications circuitry such as radio-frequency (RF) transceiver circuitry 20 formed from one or more integrated circuits such as a baseband processor integrated circuit and other radio-frequency transmitter and receiver circuits. Circuitry 18 may include power amplifier circuitry, passive RF components, antennas, and other circuitry for handling RF wireless signals.

Circuitry such as radio-frequency transceiver circuitry 20 may be connected to one or more antennas 24 by transmission line communications paths. As illustrated in the example of FIG. 1, one or more radio-frequency connectors such as connector 22 may be interposed within these transmission line paths. During testing, a radio-frequency probe may be attached to a connector such as connector 22. Radio-frequency power measurements may be made using the probe to determine whether radio-frequency power is being properly transmitted from radio-frequency transceiver circuitry 20.

Electronic device 10 may include a battery such as battery 26. Battery 26 may be used to power device 10 when device 10 is not tethered to a wired source of power.

Device 10 may be provided with a subscriber identity module (SIM) such as SIM 27. During normal operation of device 10 in a cellular telephone network, SIM card 27 may be used to establish a user's authorization to use the cellular services of the network. During testing, a version of SIM 27 that is designed to support test operations (i.e., a test SIM) may be inserted into device 10 to allow device 10 to make and receive calls with a call box. Test calls such as these may be similar too, but need not be identical to the cellular telephone calls that device 10 makes when used normally in a cellular network.

With one suitable arrangement, which is sometimes described herein as an example, device 10 may be a cellular telephone. This is, however, merely one illustrative arrangement. Device 10 may, in general, be any suitable wireless electronic device. For example, device 10 may be a portable electronic device such as a small portable computer. Device 10 may also be a somewhat smaller portable device. Examples of smaller portable devices include wrist-watch devices, pendant devices, headphone and earpiece devices, and other wearable and miniature devices. With one particularly suitable arrangement, the portable electronic devices are handheld electronic devices. Handheld devices may be, for example, cellular telephones, media players with wireless communications capabilities, handheld computers (also sometimes called personal digital assistants), remote controllers, handheld gaming devices, hybrid devices that combine features from more than one of these devices, etc. The use of handheld devices such as cellular telephone devices is generally described herein as an example, although any suitable electronic device may be tested in accordance with embodiments of the present invention if desired.

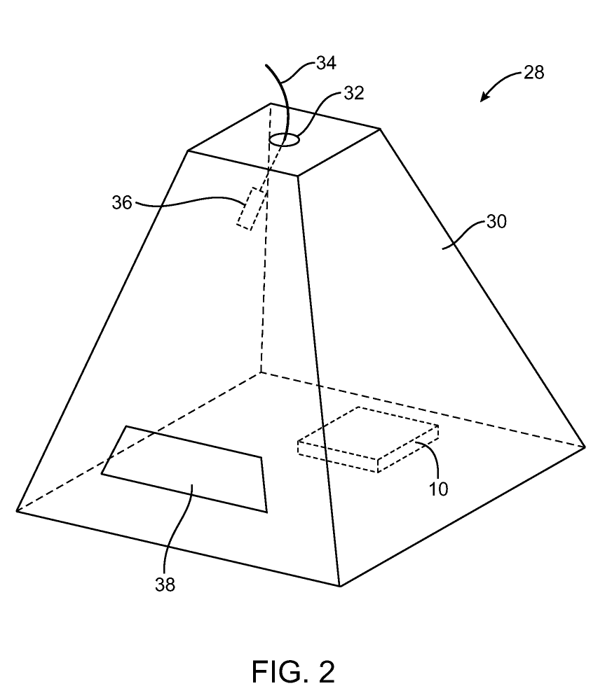

In addition to performing tests on device 10 by connecting a wired probe to radio-frequency connector 22, device 10 can be tested wirelessly. As shown in FIG. 2, for example, device 10 may be tested by performing wireless measurements on device 10 while device 10 is in a test chamber 28. Test chamber 28 may have sidewalls 30 that absorb radio-frequency signals and thereby help to contain radio-frequency signals within chamber 28. This prevents interference from outside chamber 28 from affecting tests made within chamber 28. The isolation provided by sidewalls 30 also allows multiple chambers such as chamber 28 to be operated in parallel at the same time. Even if a test is being performed in one chamber, radio-frequency signals will generally not escape from the chamber to influence tests being performed in adjacent chambers. In a typical configuration, the sidewalls of chamber 28 are configured so that chamber 28 has a pyramidal shape.

During tests, radio-frequency signals may be supplied to the interior of chamber 28 from call box test equipment via cable 34, port 32, and test head 36 (i.e., an antenna). Radio-frequency signals from test head 36 can be received by a device under test that has been placed within chamber 30 through door 38 (i.e., device 10 in the example of FIG. 2). Radio-frequency signals that are transmitted from device 10 may be received by test head 36 and may be passed to test equipment such as a call box via cable 34.

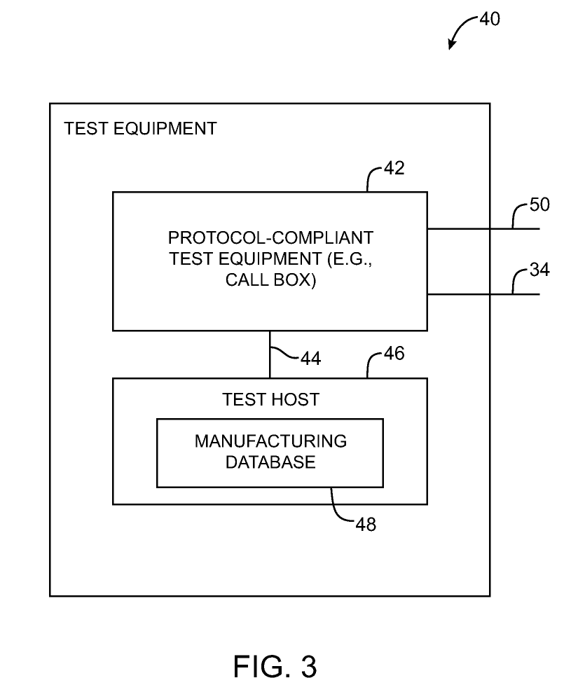

Test equipment that may be used in performing wireless tests on device 10 is shown in FIG. 3. As shown in FIG. 3, test equipment 40 may have an associated cable 34 that connects test equipment 40 to the antenna in test chamber 28 (FIG. 3). Cable 50 may be used when it is desired to form a wired connection between test equipment 40 and device 10.

Test equipment 40 may include a call box or other protocol-compliant test equipment 42 and a test host such as test host 46. A communications path such as path 44 may be used to support communications between call box equipment 42 and test host 46. A manufacturing database such as database 48 may be maintained by test equipment 40. As shown in FIG. 3, for example, test host 46 may maintain manufacturing database 48.

Test equipment 42 may be, for example, a call box for testing cellular telephones such as the CMU200 universal radio-communications tester that is available commercially from Rohde & Schwarz. Test equipment 42 preferably includes equipment that is compliant with the wireless communications protocols used by device 10, so that signaling type (call type) radio-frequency tests may be performed. For example, if device 10 supports so-called 2G, 3G, or 4 G communications protocols, test equipment 42 preferably also supports 2G, 3G, or 4 G communications protocols.

To control device 10 wirelessly during testing, test equipment 42 is preferably capable of sending messages to device 10. Such messages may be conveyed using any suitable messaging scheme. For example, messages may be conveyed that are compliant with short message service (SMS) protocols. Message protocols such as SMS message protocols are defined as part of the 3GPP 3G partnership project protocols. In particular, SMS message protocols form part of the Global System for Mobile portion of the 3GPP standard as set forth in the TS23 3GPP specifications.

If desired, different pieces of equipment may be used to support message communications functions and radio-frequency test call functions. For example, one test unit may be used to send and receive messages such as SMS messages and another unit may be used to handle test calls with device 10. Although schemes such as these may be used, it is generally preferably to use a call box for equipment 42 that is able to handle both messaging operations and signaling-type tests, as this may help to minimize test equipment complexity. If desired, test equipment 42 may include power meters, spectrum analyzers, and other such test equipment.

Path 44 may include wired and wireless paths (e.g., local area network paths based on wireless standards, Ethernet cables, etc.).

Test host 46 may be implemented using a personal computer, a workstation, other such computers, a network of computers, remote servers, or any other suitable computing equipment. Test host 46 may share test data with other computer systems such as computer systems that are associated with the engineering department of a device manufacturer or computer systems that are used by service personnel. In a typical test environment, devices are tested and test results are stored in each device. Full or abbreviated test results may also be stored in databases such as manufacturing database 48. The test results can be statistically analyzed to determine whether design changes or manufacturing changes can be made to improve yields, performance, and reliability.

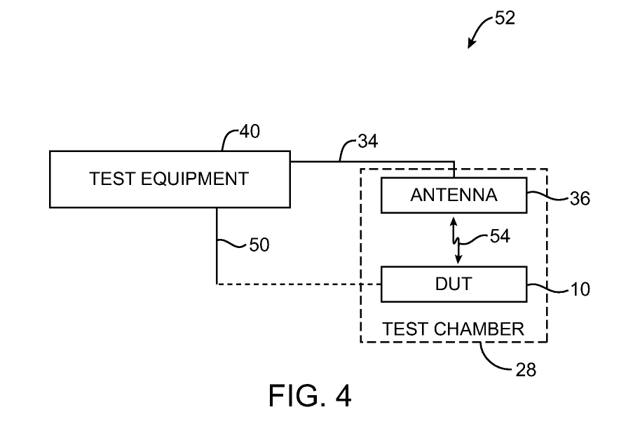

A typical test environment that may be used when testing devices such as device 10 of FIG. 1 using test equipment such as test equipment 40 of FIG. 3 is shown in FIG. 4. As shown in FIG. 4, in test system 52, test equipment 40 may communicate with device 10 using wireless path 54 or wired path 50. Wired path 50 may be formed during an initial setup process, may be formed when it is desired to save test results in device 10, or may be omitted entirely to streamline the test procedure. Communications over wireless path 54 may be supported by transmitting and receiving radio-frequency signals between test equipment 40 and device 10 using cable 34 and antenna 36 in test camber 28.

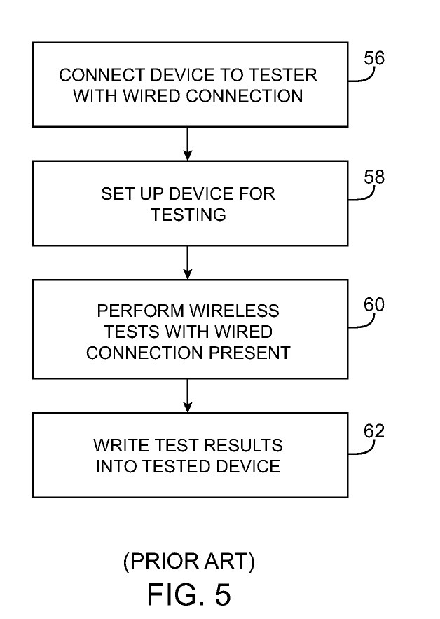

Conventional testing techniques rely on the use of a wired path such as path 50 that connects test equipment directly to a device under test. The steps involved in conventional wireless testing of a cellular telephone while using a wired connection are shown in FIG. 5.

Conventional test approaches require that test equipment be connected to a wireless device by a wired connection such as a cable terminated with a 30-pin connector that plugs into the wireless device. This connection may be made when initiating test operations (step 56 of FIG. 5). The device to be tested may be placed in a test chamber prior to performing wireless tests.

After personnel at the manufacturer have attached the test equipment to the cellular device with the cable, the cellular device may be set up for testing at step 58. During step 58, information that is specific to the device that is being tested such as the device's serial number may be conveyed to the test equipment and entered into a database.

After setup operations are complete, wireless tests may be performed (step 60). These wireless tests may involve making test telephone calls (or their testing equivalent) using call box equipment.

Following testing at step 60, test results may be written from the test equipment into memory in the tested device using the wired connection between the test equipment and the wireless device. The test results might indicate, for example, that the device was tested by a particular piece of test equipment and that the test equipment measured a particular transmitted power level when the device was directed to produce a given radio-frequency output signal during testing.

Although the conventional test approach of FIG. 5 may sometimes be satisfactory, it can lead to test errors. During the operations of step 60, the cable connector that was attached to the device at step 56 remains plugged into the device. This can affect wireless test results by altering the ground properties for the antennas in the device and by creating an unnatural ground path for interference signals. The tests that are performed at step 60 may therefore not be accurate.

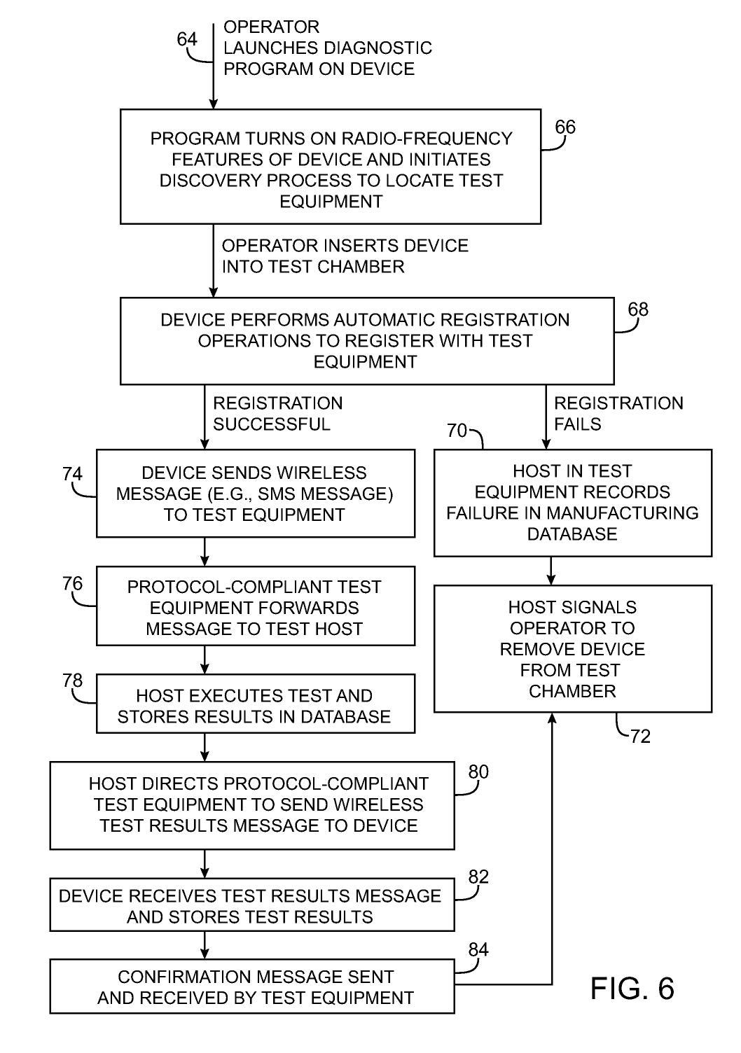

Illustrative steps involved in testing wireless devices such as cellular telephones in accordance with an embodiment of the present invention are shown in FIG. 6.

Testing of device 10 may be initiated by an operator. As indicated by line 64, an operator at a manufacturer may place device 10 in test mode by launching a diagnostic program on device 10. The diagnostic program may be launched, for example, by entering a service menu and selecting an appropriate on-screen option, by pressing a particular sequence of buttons on device 10, etc.

After the diagnostic program has been launched, the program turns on radio-frequency circuitry in device 10 and initiates a discovery process. Once the diagnostic program has been launched, the operator may insert device 10 into test chamber 28 through door 38. To avoid the testing inaccuracies that may arise when performing tests while device 10 is connected to the test equipment with a wired connection, device 10 may be placed in the test chamber 28 without any attached test cables.

While in test chamber 28, the diagnostic program can direct device 10 to perform setup operations to ensure that device 10 is properly configured for testing. These setup operations may involve turning on a baseband processor and other radio-frequency transceiver circuitry 20, confirming that a test SIM such as SIM card 27 of FIG. 1 is present within device 10, and configuring device 10 to make and receive suitable test calls (using, for example, Global System for Mobile or Universal Mobile Telecommunications Systems protocols).

The discovery process that is initiated by running the diagnostic program on device 10 may use wireless communications circuitry 18 to communicate with test equipment 40 and thereby locate the call box to be used for testing.

At step 68, after device 10 has been placed in test chamber 28 by the operator, device 10 wirelessly registers with call box 42 in test equipment 40.

If the registration process fails (e.g., due to a defect in device 10), test host 46 may record the failure in manufacturing database 48 (step 70). Test host 46 may then signal the operator to remove device 10 from test chamber 28 (step 72). For example, test host 46 may create an audible alert or message or may present instructions for the operator on a computer monitor in test equipment 40.

If the registration process of step 68 is successful, testing may proceed to step 74. At step 74, device 10 may send a wireless message to call box 42 in test equipment 40. The wireless message may be transmitted in any suitable message format. For example, the message that is transmitted may be compliant with cellular telephone communications protocols such as the short message service (SMS) protocol. This is, however, merely illustrative. Other message formats may be used if desired.

The message that is sent to the test equipment at step 74 may include information that helps call box 42 and equipment 40 to prepare for a wireless test of device 10. For example, the message may include information on the serial number of the device under test or other device identity information that uniquely identifies device 10. The message may also include information on the capabilities of device 10. As an example, the message may include information on which communications protocols are supported by device 10 (e.g., 2G, 3G, etc.) and which communications bands are supported (e.g., 850 MHz, 900 MHz, 1800 MHz, etc.). Device 10 may also include information in the message on which firmware version is installed on device 10 and information on the device type (e.g., a version number for the device). The wireless message may also include information on which type of test should be performed. This test type information may, for example, be generated automatically by the diagnostic program or may be selected by the operator as the operator interacts with the diagnostic program. The test type information may specify which wireless features of device 10 are to be tested (e.g., which communications bands are to be tested, what types of measurements are to be made by equipment 40, etc.).

If some of the information in the wireless message was previously supplied by device 10 to test equipment 40 (e.g., in an earlier wireless message or over a wired connection formed using wired connection 50 during a wired setup operation), redundant information may be omitted from the wireless message of step 74.

Call box 42 may receive the wireless message that was sent from device 10. At step 76, call box 42 may forward the received message and its contents to test host 46.

At step 78, test host 46 may receive the forwarded message from call box 42 and may initiate testing. During testing, test equipment 40 may use call box 42 to perform wireless tests in accordance with the test type instructions contained in the message from device 10 and/or in accordance with test instructions supplied by an operator at test host 46. Testing may be performed over any suitable range of communications bands and channels. For example, testing might involve making a series of telephone calls in a given communications band (e.g., 1800 MHz) for each of multiple channels within that band (as an example). Test measurements that may be made during a call between call box 42 and device 10 include transmit power, receiver sensitivity, bit error rate (BER), frame error rate, adjacent channel power, etc. These are merely illustrative examples of the types of measurements that may be made. Any suitable test equipment 40 may be used to make test measurements and, in general, any suitable tests may be implemented.

An advantage of using protocol-compliant test equipment such as call box 42 in performing the tests of step 76 is that this type of test equipment is able to perform tests that simulate actual cellular telephone calls by exercising high-level features in the cellular protocols. Device 10 is preferably loaded with a test SIM prior to testing, so device 10 is able to handle test calls just as if device 10 were establishing a wireless cellular link with regular cellular telephone network equipment. More basic measurements (e.g., power meter measurements and frequency spectrum measurements) may also be made during testing if desired. These measurements may be made using stand-alone equipment (e.g., a power meter or spectrum analyzer that is separate from a call box) or the functions available within the call box may be used to perform power and spectrum measurements). Device 10 is preferably contained within chamber 28 during testing, so that radio-frequency test signals that are created during the test (i.e., link 54 of FIG. 4) do not generally generate interference for nearby devices that are being tested in parallel. During tests, host 46 may serve as a master and call box 42 may serve as a slave (as an example).

The results of the tests that are performed by test equipment 40 during step 78 may be stored in a database. For example, test host 46 may store test results from call box 42 in manufacturing database 48. The test results may be shared with other databases if desired.

At step 80, test host 46 may direct call box 42 to store test results from the test of step 76 in device 10. In response, call box 42 may wirelessly transmit some or all of the results of the tests to device 10 for storage in memory 12 (FIG. 1). Test results may be transmitted from call box 42 to device 10 using any suitable arrangement (e.g., in a message such as an SMS message).

At step 82, device 10 may store the test results that have been received from test equipment 40 in memory 12. Some or all of the test results may be stored. Examples of test results that may be stored include results related to measured transmit power, receiver sensitivity, bit error rate (BER), frame error rate, adjacent channel power, etc. Test data may also reflect the results of radio-frequency power measurements and measurements from spectrum analyzer equipment.

Test results may include information about the test equipment that performed the tests. For example, identifying information such as a station identifier (station ID) or other identifier that identifies call box 42, test host 46, and other components in test equipment 40 may be included in the test results that are wirelessly transmitted to device 10 and stored in memory 12.

The test results that are transmitted to device 10 may also include information on the date and time at which the test was performed, information on the location at which the test was performed, other information about the test environment, etc. This data may be stored in memory 12 in a secure location (e.g., in a secret and potentially encrypted location that is accessible only to service personnel). In the event that device 10 is serviced, the test results may be examined by service personnel. A database may be maintained by the service personnel that links service issues with particular test results information. The data in this type of database may be analyzed to identify manufacturing trends such as trends in yield and reliability and testing issues. Service database content may be linked with or incorporated into manufacturing databases such as database 48 of FIG. 3.

After the test results from test equipment 40 have been stored by device 10, device 10 may wirelessly transmit one or more optional confirmation messages to test equipment 40 (step 84). A confirmation message may, as an example, be sent in the form of an SMS message. The optional confirmation message may serve as a form of handshaking that informs test equipment 40 that the test results have been successfully stored. If the test results are not properly received, device 10 may send a command to test equipment 40 requesting that the test results be retransmitted.

After test equipment 40 receives the confirmation message, test host 46 may signal the operator that testing is complete and that device 10 may be removed from test chamber 28 (step 72).

If desired, multiple tests may be performed without removing device 10 from chamber 28. For example, rather than sending a confirmation message at step 82, testing may continue at step 74, where device 10 can send a message that informs test equipment 40 of additional tests that should be performed. If a first test was performed in a first communications band, a second test might, as an example, be performed in a second communications band. Additional testing may also be used to test additional aspects of the wireless performance of device 10, to test additional channels in a given band, etc. In situations in which multiple tests are being performed, it may not be necessary during subsequent test loops for all of the setup parameters in the SMS message of step 74 to be resent from device 10 to test equipment 40. For example, the first time that device 10 sends a wireless message to test equipment 40 to set up a test, device 10 may provide information on the capabilities of device 10 and the device's serial number or other identity information. In the event that processing loops back to step 74 to set up additional tests, it may not be necessary to resend this information to test equipment 40.

If desired, test equipment 40 and device 10 may communicate with each other during testing using wireless messages. For example, during the testing operations of step 78, call box 42 may send wireless test control messages to device 10. These test control messages may serve as commands for device 10. Test equipment 40 may send a command to device 10 to place device 10 in a desired configuration before performing a particular portion of a test. As an example, if it is desired to perform wireless testing while device 10 is in sleep mode, test equipment 40 may transmit a wireless message to device 10 during testing that instructs device 10 to enter a sleep state. Once device 10 has entered sleep mode in response to this command, test equipment 40 may perform appropriate tests.

The ability to communicate between test equipment 40 and device 10 using wireless messages during testing (i.e., during step 74) may also be helpful in situations in which handover functionality is not available in equipment 40 to support continuous device testing. When equipment 40 that does not support this type of testing functionality is used, it is generally necessary to perform a new setup process each time a different test is desired. By sending wireless messages during testing, some or all of these setup operations may be avoided. A continuous set of tests may therefore be performed with necessary changes to the operating mode of device 10 being handled by real-time wireless commands from test equipment 40.

With the wireless messaging schemes of the present invention, there is no need to reestablish a communications link (link 54 of FIG. 4) between device 10 and call box 42 before testing can continue. By sending test commands from call box 42 to device 10 in the form of wireless messages and by receiving associated wireless messages from device 10, test equipment 40 may perform a continuous set of tests (e.g., tests for different communications bands) without reestablishing communications link 54 in a new set up process (i.e., a setup process of the type described in connection with launching the diagnostic program, registering the device, etc.).

If desired, some communications between test equipment 40 and device 10 may be performed using wired connections. For example, a wired connection may be formed using a cable such as cable 50 of FIG. 4 during setup operations. With this type of arrangement, wireless messages such as those transmitted from device 10 to test equipment 40 during step 74 may be supplemented or replaced by wired communications transmitted over cable 50. A wired connection may also be used after testing is complete to store test results in device 10. This arrangement may be used to replace or supplement the wireless transmission of test results to device 10.

The foregoing is merely illustrative of the principles of this invention and various modifications can be made by those skilled in the art without departing from the scope and spirit of the invention.

What is claimed is:

1. A method of testing wireless electronic devices using test equipment, comprising:
placing a wireless electronic device in a test chamber; and
with the test equipment, receiving a wireless message that was transmitted from the device that is in the test chamber that instructs the test equipment to perform wireless tests on the wireless electronic device.

2. The method defined in claim 1 wherein the wireless device in the test chamber is unconnected by wired cable to the test equipment, the method further comprising:
while the wireless device is unconnected by wired cable to the test equipment, transmitting a wireless control message from the test equipment that configures the wireless electronic device for a given test.

3. The method defined in claim 1 wherein the wireless device in the test chamber is unconnected by wired cable to the test equipment, the method further comprising:
while the wireless device is unconnected by wired cable to the test equipment, transmitting a wireless control message from the test equipment that configures the wireless electronic device for a given test, wherein the wireless control message is compliant with cellular telephone communications protocols.

4. The method defined in claim 1 wherein the wireless device in the test chamber is unconnected by wired cable to the test equipment, the method further comprising:
while the wireless device is unconnected by wired cable to the test equipment, transmitting a wireless control message from the test equipment that configures the wireless electronic device for a given test, wherein the wireless control message is a short message service (SMS) message.

5. The method defined in claim 1 wherein the wireless electronic device comprises a cellular telephone, wherein the test equipment comprises a call box, and wherein receiving the wireless message comprises receiving the wireless message with the call box.

6. The method defined in claim 1 wherein the wireless electronic device comprises a cellular telephone, wherein the test equipment comprises a call box, wherein receiving the wireless message comprises receiving the wireless message with the call box, and wherein the wireless message is compliant with cellular telephone communications protocols.

7. The method defined in claim 1 wherein the wireless electronic device comprises a cellular telephone, wherein the test equipment comprises a call box, wherein receiving the wireless message comprises receiving the wireless message with the call box, and wherein the wireless message is a short message service (SMS) message.

8. The method defined in claim 1 wherein the wireless electronic device comprises a cellular telephone and wherein placing the wireless electronic device in the test chamber comprises placing the cellular telephone in the test chamber.

9. The method defined in claim 1 wherein the wireless tests are performed by the test equipment and produce test results and wherein the wireless electronic device comprises memory, the method further comprising:
storing the test results in the memory.

10. The method defined in claim 1 wherein the wireless tests are performed by the test equipment and produce test results, the method further comprising:
wirelessly transmitting the test results to the wireless electronic device in the test chamber using the test equipment.

11. The method defined in claim 1 wherein the wireless tests are performed by the test equipment and produce test results, the method further comprising:
wirelessly transmitting the test results from the test equipment to the wireless electronic device in the test chamber in a message that is compliant with cellular telephone communications protocols.

12. The method defined in claim 1 wherein the wireless tests are performed by the test equipment and produce test results, the method further comprising:
wirelessly transmitting the test results from the test equipment to the wireless electronic device in the test chamber in a short message service (SMS) message.

13. The method defined in claim 1 further comprising:
in response to receiving the wireless message that was transmitted from the device in the test chamber, testing the wireless electronic device with the test equipment, wherein testing the wireless electronic device with the test equipment comprises performing a test selected from the group consisting of: a bit error rate test, an adjacent channel power test, a frame error rate test, a transmit power test, and a receiver sensitivity test.

14. The method defined in claim 1 wherein the test equipment comprises a call box, the method further comprising:
in response to receiving the wireless message that was transmitted from the device in the test chamber, testing the wireless electronic device with the call box, wherein testing the wireless electronic device with the call box comprises performing a test selected from the group consisting of: a bit error rate test, an adjacent channel power test, a frame error rate test, a transmit power test, and a receiver sensitivity test.

15. A test system for testing a cellular telephone, comprising:
a test chamber in which the cellular telephone is placed for testing, wherein the test chamber has an associated antenna; and
cellular telephone test equipment that is configured to receive a short message service (SMS) message from the cellular telephone through the antenna in response to which the cellular telephone test equipment performs tests on the cellular telephone.

16. The test system defined in claim 15 wherein the cellular telephone test equipment comprises a call box that receives the SMS message, wherein the SMS message includes an identifier that identifies the cellular telephone that has been placed in the test chamber.

17. The test system defined in claim 16 wherein the call box is configured to transmit wireless SMS control messages to the cellular telephone during testing.

18. A method for testing a cellular telephone in a test chamber using test equipment that includes a call box and a test host, comprising:
while the cellular telephone is in the test chamber, communicating between the call box and the cellular telephone using a short message service (SMS) message.

19. The method defined in claim 18 further comprising:
transmitting at least one SMS test control message from the test equipment to the cellular telephone to place the cellular telephone in a sleep mode.

20. The method defined in claim 19 further comprising:
while the cellular telephone is in the sleep mode, performing wireless testing on the cellular telephone using the call box.

21. The method defined in claim 20 wherein test results are produced as a result of the wireless testing performed on the cellular telephone using the call box, the method further comprising:
transmitting the test results from the call box to the cellular telephone in a test results SMS message.

22. The method defined in claim 18 further comprising:
with the call box, performing wireless tests on the cellular telephone in response to the SMS message to produce test results.

23. The method defined in claim 22 further comprising:
transmitting the test results from the call box to the cellular telephone in a test results SMS message.

24. The method defined in claim 18 wherein the SMS message includes identity information that identifies the cellular telephone to the test equipment and wherein communicating between the call box and the cellular telephone comprises receiving the SMS message that includes the identity information that identifies the cellular telephone to the test equipment.

25. The method defined in claim 18 further comprising:
transmitting at least one SMS test control message from the test equipment to the cellular telephone to control the cellular telephone during testing by the call box.

26. The method defined in claim 18 wherein the SMS message includes information on a desired test type that specifies a type of test to be performed by the call box on the cellular telephone and wherein communicating between the call box and the cellular telephone comprises receiving the SMS message that includes the information on the desired test type with the call box and forwarding the received SMS message to the test host.
